(19) United States
(12) Patent Application Publication
(10) Pub. No.: US 2025/0020867 A1
(43) Pub. Date: Jan. 16, 2025

(54) MULTI-OPTICAL WAVEGUIDE PLUG AND OPTICAL WAVEGUIDE CONNECTOR COMPRISING THE PLUG

(71) Applicant: HUBER+SUHNER Cube Optics AG, Mainz (DE)

(72) Inventors: Katrin SÖRENSEN, Mainz (DE); Dietrich DREWS, Selzen (DE); Ingo SMAGLINSKI, Mainz (DE); Thomas PETIGK, Rüsselsheim (DE)

(73) Assignee: HUBER+SUHNER Cube Optics AG, Mainz (DE)

(21) Appl. No.: 18/769,780

(22) Filed: Jul. 11, 2024

(30) Foreign Application Priority Data
Jul. 13, 2023 (DE) 102023118609.4

(51) Int. Cl. G02B 6/32; G02B 6/38

(52) U.S. Cl. CPC G02B 6/32; G02B 6/3881

(57) ABSTRACT

The present invention relates to an optical waveguide connector for optically connecting a number N of first optical waveguides, wherein N is ≥2, to a number M of second optical waveguides, wherein M is ≥1, wherein the optical waveguide connector holds an end portion of each first optical waveguide with an optical waveguide end face and comprises a number N of lenses each having an entry face facing one of the first optical waveguides and an outlet face facing away from that first optical waveguide. Each lens is assigned to exactly one first optical waveguide and each optical waveguide is assigned to exactly one lens, and the lenses are configured and arranged in such a way that a beam emerging from one of the first optical waveguides in a propagation direction strikes the entry face of the assigned lens and is projected as a convergent beam onto the outlet face of the assigned lens.

### RELATED APPLICATION DATA

This application claims the benefit of and the priority to German Application No. 10 2023 118 609.4, filed Jul. 13, 2023, the entire contents of which is hereby incorporated by reference in its entirety.

### TECHNICAL FIELD

The present invention relates to an optical waveguide connector and an optical waveguide plug for an optical waveguide connector for optically connecting optical waveguides.

### BACKGROUND

Optical waveguides are cables for transmitting light signals. Optical waveguides often have fibres made of quartz glass. They are also colloquially referred to as fibre optic cables, even if they do not contain any glass fibres.

Such optical waveguides are used in particular in communications engineering for the transmission of information signals. However, such optical waveguides are not infinitely long, so it is necessary to connect several optical waveguides together. Plug connections or splices are often used for the connection. During splicing, the fibre ends of two optical waveguides to be connected are melted and pushed together. Plug connections are generally used for the detachable connection of optical waveguides. In most cases, plug-plug connections are used here, which are designed to minimise signal attenuation. However, in the state of the art, optical waveguides with the same diameters (field diameters) that can be used for signal transmission are always connected to each other.

A distinction is usually made between single-mode optical waveguides and multimode optical waveguides. However, these differ in their field diameters.

However, hollow fibres with one or more cavities in the cross-section have also been known for some time. These can also be used to conduct light. Such hollow fibres, also known as hollow-core fibres, have advantages over solid-core fibres in principle. However, it has only recently become possible to produce hollow-core fibres in long lengths and of sufficient quality at an acceptable cost. This is why solid-core optical fibres have been and continue to be used.

There are already optical signal transmission systems that use hollow fibres. However, it is not easy to connect several hollow fibres together. In addition, it is not known how to couple a hollow-core fibre with a solid-core fibre in a pluggable manner without unwanted back reflections in a cost-effective way, so the optical waveguides cannot be used in combination. One of the reasons for this is that the diameter that can be used for light transmission (field diameter) for hollow-core fibres is about twice as large as the field diameter for solid-core fibres. This has slowed down the spread of hollow-core fibres. In addition, it can be cumbersome to connect each individual optical waveguide to another optical waveguide using a plug connection.

### SUMMARY

Based on the described prior art, it is therefore the problem of the present invention to provide a connection technique by which a plurality of optical waveguides can be simultaneously connected to each other, wherein hollow-core optical waveguides can be connected to each other as well as optical waveguides with different field diameters, such as a solid-core optical waveguide to a hollow-core optical waveguide.

With regard to the optical waveguide plug, this problem is solved by an optical waveguide plug for an optical waveguide connector for optically connecting a number N of first optical waveguides, wherein N is ≥2, to a number M of second optical waveguides, wherein M is ≥1. In this case, the optical waveguide plug holds an end portion of each first optical waveguide with an optical waveguide end face and has a number N of lenses, each of which has an entry face facing one of the first optical waveguides and an outlet face facing away from this first optical waveguide, wherein each lens is associated with exactly one first optical waveguide and each optical waveguide is associated with exactly one lens and the lenses are configured and arranged such that a beam of rays emerging from one of the first optical waveguides in a propagation direction strikes the entry face of the associated lens and is projected as a convergent beam of rays onto the outlet face of the associated lens.

As a rule, N equals M, as only then can the signals of all optical waveguides be transmitted in both directions. In principle, however, M could also be greater or less than N, so that not all optical waveguides are connected or several first optical waveguides are connected to a second optical waveguide.

If a first optical waveguide is considered, the optical waveguide plug holds an end section of this first optical waveguide with a first optical waveguide end face and an associated lens with an entry face facing the optical waveguide and an outlet face facing away from this first optical waveguide. The lens is configured and arranged in such a way that a beam emerging from this first optical waveguide hits the entry face of the lens and is projected as a convergent beam onto the outlet face of the lens.

Information carried by the beam is thus projected from the first optical waveguide onto the outlet face, where it can be further processed or forwarded. In a preferred embodiment, the first optical waveguide is a hollow-core optical waveguide.

It is particularly preferable if the beam is focused on the outlet face of the lens, as a second waveguide, which is to receive the signal, can then be positioned with its end face directly on the outlet face of the lens. Alternatively, however, the focal point can also be at a distance from the exit surface. However, it is necessary that a convergent beam is projected onto the outlet face of the lens.

Preferably, the diameter of the beam on the outlet face is less than 100 μm, particularly preferably less than 25 μm and most preferably less than 10 μm.

In a preferred arrangement, the diameter of the beam on the outlet face of the lens essentially corresponds to an outlet face of a second optical waveguide, e.g. a solid core optical waveguide, so that, if the focusing is selected accordingly, the entire light signal is focused on a section of the outlet face whose extent essentially corresponds to the typical extent of the core of the second optical waveguide. By selecting a suitable lens, the light signal can be adapted to the core diameter of the second optical waveguide in which the signal is to be transmitted.

The lenses can be configured as a lens array. Preferably, the lens array is configured in one piece.

The optical waveguide plug can be used for both signal transmission directions. If a light signal is provided at the outlet face of the lens, e.g. by a second optical waveguide configured as a solid-core optical waveguide, this is imaged by the lens onto the end face of the first optical waveguide, e.g. configured as a hollow-core optical waveguide.

In order to simplify the following description of the invention, only the case in which a light signal is provided by the first optical waveguide configured as a hollow-core optical waveguide and focused onto the outlet face of the lens is described below. However, the optical waveguide plug can also be used in the opposite direction of signal transmission. A solid-core optical waveguide, e.g. a single-mode or a multimode optical fibre, can also be provided as the first optical waveguide instead of the hollow-core optical waveguide.

In a preferred embodiment, it is provided that the optical waveguide plug has a protective housing, wherein both the end sections of the first optical waveguides and each lens are either arranged in the protective housing or close an opening of the protective housing.

In this case, the end sections of the optical waveguides can be guided into the housing through one or more inlet openings. At least one section of each lens can be inserted into one or more output openings so that the lenses close the output openings like a window.

The area between the end face of the first optical waveguides and the entry faces of the lenses should be in a dust-free environment. Therefore, the input and output openings must still be sealed if they are not sufficiently closed by the end sections of the first optical waveguides or the lenses. This can be done, for example, with the help of adhesive, which also fixes the end sections of the first optical waveguides or the lenses in the input and output openings. The protective housing is preferably sealed dust-tight. The protective housing should have at least protection class IP5X and preferably protection class IP6X. Furthermore, the protective housing should also be sealed against moisture, so that in a preferred embodiment it additionally or alternatively fulfils at least protection class IPX1, preferably protection class IPX3 and most preferably protection class IPX5.

In a preferred embodiment, it is provided that the protective housing has an input surface and an output surface between which one or more through channels or grooves extend. The through channels do not necessarily have to extend completely from the input surface to the output surface, but may have interruptions or be connected to each other in sections. In a preferred embodiment, N through-channels are provided so that each first optical waveguide is assigned its own through-channel. Alternatively, however, several first optical waveguides can also be assigned to one and the same through-channel.

At least part of the end section of each hollow-core optical waveguide is held in one of the passage channels or in one of the grooves. Preferably, both the end section of the hollow-core optical waveguide and at least a section of the associated lens are arranged in the through channel or groove. The lens is arranged closer to the output surface than the end section of the hollow-core optical waveguide.

The arrangement in the through-channel ensures that there are no external influences, such as dust or moisture, between the end face of the hollow-core optical waveguide and the entry face. This means that the signal strength of the light signal is practically not reduced. It can be advantageous if the through-channel is sealed, i.e. both the end section of the hollow-core optical waveguide and the lens seal the through-channel from both sides. This embodiment with a through channel is particularly suitable for small numbers N, e.g. N=2, of first optical waveguides.

It is possible for each through channel to have two sections with different cross-sections, wherein the end section of the hollow-core optical waveguide is arranged at least partially in the section with a smaller cross-section and the lens is arranged in the section with a larger cross-section. In order to effectively focus the light signal onto the outlet face, the lens must generally have a certain minimum diameter. Therefore, the lens usually has a larger cross-section than the hollow-core optical waveguide. The through channel can therefore have a smaller cross-section in the area in which the hollow-core optical waveguide is guided. This simplifies the fixing of the hollow-core optical waveguide within the through channel.

In a preferred embodiment, the protective housing has one or more abutments which are intended to abut against corresponding abutment surfaces of the end sections of the first optical waveguides and/or the lenses in order to set the position of the end sections of the first optical waveguides and/or the lenses relative to the protective housing in the propagation direction and/or in the lateral direction.

For example, the protective housing may have a stop for the lenses or the lens array against which the lens abuts so that movement of the lenses in the direction of the hollow-core optical waveguide is prevented.

Alternatively, or in combination with this, each through-channel can have a stop for the hollow-core optical waveguide, against which the hollow-core optical waveguide abuts, so that movement of the hollow-core optical waveguide in the direction of the lens is prevented.

Alternatively or in combination with this, the stop can also be configured in such a way that it essentially and preferably completely prevents lateral movement between the lens and/or hollow-core optical waveguide relative to the protective housing.

Such stops can be realised, for example, by through-channel sections with different cross-sections. If the protective housing and, in particular, the through-channel therein are precisely manufactured, the adjustment of the hollow-core optical waveguide and lens can be carried out simply by positioning the relevant elements at the respective stop.

In a further preferred embodiment, it is provided that the outlet face of the lens closes the through channel at the output surface, preferably flush. On the one hand, this measure ensures that no impurities collect in the passage channel. On the other hand, the outlet face of the lens can be accessed, e.g. to clean it, without the passage channel having a disruptive influence.

In an alternative embodiment, it is provided that the lens closes the passage channel at the output surface, wherein the outlet face protrudes beyond the output surface. It is possible to coat the protruding part of the lens with an adhesive, wherein the outlet face has no adhesive.

In a further preferred embodiment, it is provided that the protective housing has a transverse channel which intersects the through-channel, wherein preferably the transverse channel traverses the protective housing completely. Even if the transverse channel does not necessarily have to run at right angles to the through-channel, this is generally the preferred embodiment. The transverse channel can be used to access the through-channel from the outside in order to adjust the hollow-core optical waveguide within the through-channel and fix it in place using adhesive, for example. As soon as the hollow-core optical waveguide and lens are positioned exactly relative to each other, the hollow-core optical waveguide can be fixed, e.g. glued, within the through-channel. Several transverse channels can also be provided, e.g. a separate transverse channel for each through-channel. The through-channels can also have sections in which several or even all through-channels are connected to each other. In this case, the transverse channel can intersect the through-channel in such a section.

In a particularly preferred embodiment, an adjusting device for adjusting the end section of the hollow-core optical waveguide is arranged in the transverse channel. This adjustment device can have a sleeve element with a transverse bore or a transverse recess, wherein the end section of the hollow-core optical waveguide is guided through the transverse bore or the transverse recess. If the sleeve element is now moved relative to the transverse channel and thus also relative to the through-channel, this leads to a movement of the end section of the hollow-core optical waveguide within the through-channel, whereby the end section of the hollow-core optical waveguide can be adjusted. For this purpose, a signal can be applied to the hollow-core optical waveguide and the light spot projected onto the outlet face can be observed. As soon as this light spot has the desired properties (position on the outlet face, diameter of the light spot), i.e. as soon as the hollow-core optical waveguide has assumed the desired position relative to the entrance face of the lens, the end section can be bonded within the through-channel.

It is possible, for example, that the sleeve element and the through-channel are filled with adhesive, at least in sections, in the area in which the end section of the hollow-core optical waveguide is arranged. In this case, the sleeve element remains in the optical waveguide plug after adjustment.

It is also possible to construct the sleeve element in two parts, wherein the two parts, coming from different directions of the transverse channel, guide the end section of the hollow-core optical waveguide between them. This embodiment facilitates the insertion of the end section of the hollow-core optical waveguide and the sleeve element.

In a further preferred embodiment, the protective housing is configured in several parts, wherein at least one part has a plurality of grooves for receiving a section of the first optical waveguide in each case. The grooves are arranged in such a way that when the protective housing is assembled, the grooves form sections of through-channels.

In a further preferred embodiment, it is provided that the end faces of the first optical waveguides and the lenses are arranged at a distance from each other.

This improves the imaging properties of the lens. In particular, back reflections can be reduced as a result. In a preferred embodiment, the lenses have an anti-reflective coating. An anti-reflective coating can thus be arranged on the entry face and/or the outlet face. If the lens has a refractive index n_{Li} and the medium arranged in the through-channel, i.e. usually air, has a refractive index nₘ, the refractive index n1 of the anti-reflective coating applied to the entry face is n₁=\sqrt{n_{Li}n_{M}}.

In another preferred embodiment, N≤16 and preferably N=8. This means that a large number of optical waveguide pairs can be connected to each other with one plug connection.

It is also advantageous if a plurality and preferably all lenses are configured as a lens array.

However, unwanted back reflections can occur at the transition between the lenses and the second waveguide, which reduce the signal strength, among other things.

To reduce unwanted back reflections, at least one lens and preferably each lens can be configured as a 2-section lens and have at least two sections, namely a first section, which is bounded by the entry face, and a second section, which is bounded by the outlet face, wherein the refractive index n1 of the first section differs from the refractive index n2 of the second section.

For special applications, more than two sections can also be provided. For example, the lens can have three sections, each with a different refractive index.

In this case, the first sections of several and preferably all lenses can be configured in one piece. Alternatively or in combination, the second sections of several and preferably all lenses can be configured in one piece. This greatly facilitates the manufacture of the 2-section lenses and the adjustment of the 2-section lenses in the optical waveguide plug.

If the lens consists of several parts, these parts can be bonded together with an adhesive. The thin adhesive layer then does not form a lens section in the sense of the present invention. In a preferred embodiment, it is therefore provided that each section of the lens has a thickness of at least 0.2 mm and preferably of at least 0.3 mm, so that the beam of light travels a distance of at least 0.2 mm or 0.3 mm in each section as it passes through the lens.

In a preferred embodiment, the refractive index n2 of the second section is less than the refractive index n1 of the first section, wherein preferably the refractive index n2 is less than 1.5 and particularly preferably 1.5>n₂>1.4. This choice of refractive index has proven to be effective. The refractive index n2 can preferably be adapted to the refractive index of a solid core fibre used as the second optical waveguide.

For example, the first section can be made of a different material than the second section. It is also advantageous if the refractive index n₁ within the first section and/or the refractive index n₂ within the second section is constant, as the 2-section lens can then be produced more easily. It has been shown that it is particularly preferable for the second section in the direction of propagation to have a greater length than the first section in the direction of propagation.

In a further preferred embodiment, the 2-section lens is configured in two parts with a first part comprising the first section and a second part comprising the second section. The parts can therefore be manufactured separately and positioned next to each other, wherein the two parts of the 2-section lens particularly preferably have contact surfaces facing each other, at which the two parts are in contact with each other directly or via an adhesive layer arranged between them, so that a beam of light emerging from the first optical waveguide associated with the 2-section lens strikes the entry face of the first part and enters the second part via the contact surfaces. The second part can, for example, be a glass body with parallel or almost parallel input and output surfaces. It is not necessary for each part to have a curved surface. It is only essential that the combination of the two parts, i.e. the composite 2-section lens, produces a convergent beam from the light signal emerging from the end face of the first optical waveguide. In a preferred embodiment, the two parts are bonded together so that a thin layer of adhesive is formed between the two parts. Alternatively, the two parts can also touch each other directly at their contact surfaces without an adhesive layer.

In a further preferred embodiment, the contact surface of the second part and the outlet face are each configured to be flat but not parallel to each other. The contact surface of the second part can be aligned perpendicular to the direction of propagation. Alternatively, the outlet face of the second part can also be configured to be convexly curved.

With regard to the optical waveguide connector, the problem mentioned at the beginning is solved by an optical waveguide connector for optically connecting a number N of first optical waveguides, wherein N≥2, which each have an end section, to a number M of second optical waveguides, wherein M≥1, which each have an end section. The optical waveguide connector comprises a first optical waveguide plug, in which the end sections of the first optical waveguides are held with a first optical waveguide end face, and a second optical waveguide plug, in which the end sections of the second optical waveguides are held with a second optical waveguide end face, wherein each first optical waveguide end face is assigned exactly one second optical waveguide end face, wherein at least one lens is arranged between each first optical waveguide end face and the second optical waveguide end face associated therewith in such a way that a light beam emerging from the first optical waveguide end face is imaged onto the second optical waveguide end face, wherein an optical waveguide plug of the type described above is provided as the first optical waveguide plug, wherein an optical waveguide plug of the type described above is preferably provided as the first optical waveguide plug and an optical waveguide plug of the type described above is preferably provided as the second optical waveguide plug.

In order to simplify the following description of the optical waveguide connector according to the invention, only the case is described below in which a light signal is provided by one of the first optical waveguides configured as a hollow-core optical waveguide and is focused on the outlet face of one of the lenses. In the case described below, a solid-core optical waveguide is provided as the second optical waveguide. However, the optical waveguide connector can also be used in the opposite direction of signal transmission. A single-mode or multimode optical fibre can also be provided as the first optical waveguide instead of the hollow-core optical waveguide. Finally, it is also possible that a hollow-core optical waveguide is provided as the first and second optical waveguide. In this case, two lenses are arranged between each first optical waveguide end face and the second optical waveguide end face assigned to it.

The lens is preferably arranged in such a way that it touches the solid core end face. An anti-reflective coating can then be arranged on the outlet face. If the lens has a refractive index n_{Li} and the core of the solid-core light guide has a refractive index of n_{F}, the refractive index n₂ of the anti-reflective coating applied to the outlet face should result in n₂=\sqrt{n_{F}n_{M}}. If hollow-core optical waveguides are connected to each other instead, the lenses of the first and second optical waveguides preferably touch each other.

Furthermore, a pre-tensioning device can be provided which pre-tensions the outlet face of the lens of the first optical waveguide plug against the solid core end face or against the outlet face of the second optical waveguide plug.

In a further preferred embodiment, the second optical waveguide used is a solid core optical waveguide whose core has a refractive index which deviates from the refractive index of the second section of the lens by no more than 10%, preferably by no more than 3% and most preferably by no more than 1%.

For example, already known optical waveguide connectors, such as LC plugs, can also be used for connecting solid-core optical waveguides to hollow-core optical waveguides or for connecting hollow-core optical waveguides to each other or for connecting solid-core optical waveguides with different field diameters, if the LC plug is configured as described.

Further advantages, features and possible applications of the present invention will become clear from the following description of preferred embodiments and the associated figures. It shows:

### BRIEF DESCRIPTION OF THE DRAWINGS

FIG. 1 is a sectional view of an optical waveguide plug with optical waveguide.

FIG. 2 is a sectional view of a protective housing of the embodiment of FIG. 1.

FIG. 3 is a perspective view of the adjustment device of the embodiment of FIG. 1.

FIG. 4 is a sectional view through the protective housing with the adjustment device of the embodiment of FIG. 1 inserted.

FIG. 5 is a view as in FIG. 4, but with the optical waveguide inserted.

FIG. 6 is a sectional view through a second embodiment of an optical waveguide plug.

FIG. 7 is a sectional view of an optical waveguide connector.

FIG. 8 is a sectional view of a third embodiment of an optical waveguide plug.

FIG. 9 is a perspective sectional view of the third embodiment.

FIG. 10 is a sectional view of a fourth embodiment of an optical waveguide plug.

FIG. 11 is a perspective sectional view of the fourth embodiment.

FIG. 12 is a sectional view of a second embodiment of an optical waveguide connector.

FIG. 13 isa perspective view of a fifth embodiment of an optical waveguide plug according to the invention.

FIG. 14 is a perspective view of the protective housing of the fifth embodiment.

FIG. 15 is an exploded view of the protective housing of FIG. 14.

FIG. 16 is a perspective view of the opened protective housing of FIG. 14.

FIG. 17 is a sectional view of the protective housing of FIG. 14.

FIG. 18 is a perspective sectional view of the protective housing of FIG. 14.

### DETAILED DESCRIPTION

The figures show a total of five different embodiments of the invention according to the invention. For each of the first four embodiments, sectional views through a first optical waveguide are shown. It is understood that further first optical waveguides are arranged parallel thereto and are therefore not shown in the figures. For the fifth embodiment, the arrangement of all first optical waveguides is shown.

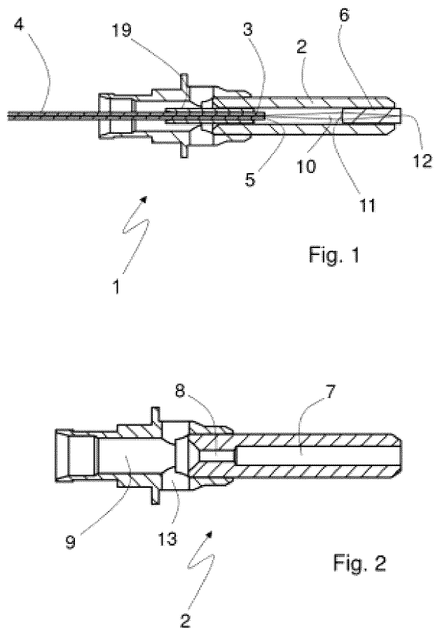

FIG. 1 shows a sectional view of a first preferred embodiment of an optical waveguide plug 1.

In the sectional view of the optical waveguide plug 1 shown, an end section 3 of a hollow-core optical waveguide 4 is shown. This end section 3 is held in a through-channel 7, 8, 9 (shown in FIG. 2). A lens 6 is also provided. A light beam or beam bundle 10 emerges from an end face 5 of the end section 3 of the hollow-core optical waveguide 4 and widens in the direction of the lens 6. The lens 6 is configured such that it projects the light beam 10, which strikes an entry face 11 of the lens 6, as a convergent beam onto the outlet face 12 of the lens 6 and preferably focusses it. In the best case, the outlet face 12 is located in the focus of the convergent beam. An arrangement outside the focus is also possible, even if this is disadvantageous.

In the embodiment shown, a capillary 19 is provided which surrounds part of the end section 3 of the hollow-core optical waveguide 4. The capillary 19 can be dispensed with. In this case, the through-channel is preferably configured in a stepped manner.

Even if the preferred embodiment describes that a light beam emerges from the end face 5 of the end section 3 of the hollow-core optical waveguide 4 and strikes the entry face 11 lens 6, the signal path can also be reversed. A signal coupled in via the outlet face 12 of the lens 6 can also be mapped onto the end face 5 of the end section 3.

The described elements of the optical waveguide plug are arranged in the protective housing 2 shown in FIG. 2. The protective housing 2 has several through-channels, only one of which can be seen in the sectional view. In the embodiment shown, this through-channel has three sections, namely a front section 7, which is intended to receive the lens 6, and a centre section 8, which is intended to receive the end section 3 of the hollow-core optical waveguide 4 and whose cross-section is reduced compared to the cross-section of the front section 7. Finally, there is a rear section 9 of the through-channel, which again has a slightly larger cross-section. The rear section 9 is of secondary importance for the invention and can have any desired cross-section.

Furthermore, a transverse channel 13 is provided, via which access to the through-channel is granted from the lateral surface of the protective housing 2.

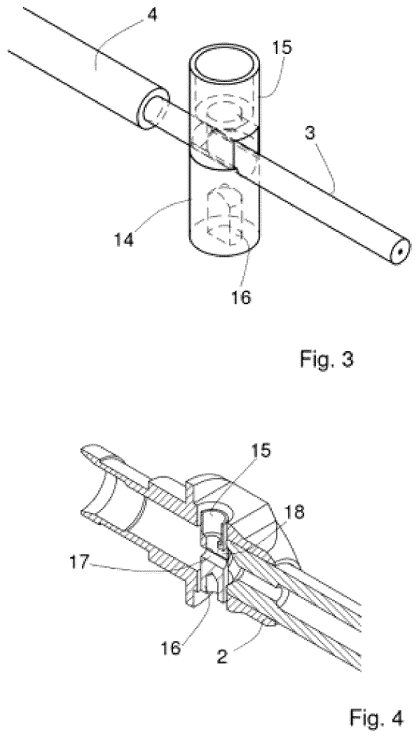

An adjusting device 14, 15, which is shown in FIG. 3, is arranged in the transverse channel 13. The adjusting device 14, 15 consists of two elements 14 and 15 which, in the assembled state as shown in FIG. 3, have a transverse bore or a transverse recess through which the end section 3 of the hollow-core glass fibre 4 can be guided. In an alternative embodiment, the upper element 15 of the adjusting device 14, 15 can be dispensed with. In the example shown, the lower element 14 of the adjusting device has a handling recess 16, indicated in the drawing, with which the adjusting device 14, 15 can be moved in the direction of the transverse channel 13 and/or rotated about the axis of the transverse channel 13. The upper element 15 can also have a handling recess. This allows the end section 3 of the hollow-core optical waveguide 4 to be adjusted relative to the protective housing 2. As soon as the relative position is set to the desired position, adhesive can be filled in via the opening of the sleeve-shaped configured part 15 of the adjusting device, so that the adhesive is distributed through the transverse recess 18 in the direction of the end section 3, where it creates a firm connection between the end section 3 and the protective housing 2 within the centre section 8 of the through-channel 7, 8, 9. The adjusting device 14, 15 can also be configured in one piece, wherein the end section 3 would then have to be guided through the transverse recess 18 of the adjusting device 14, 15. The two-part design has the advantage that the waveguide connector is easier to fit.

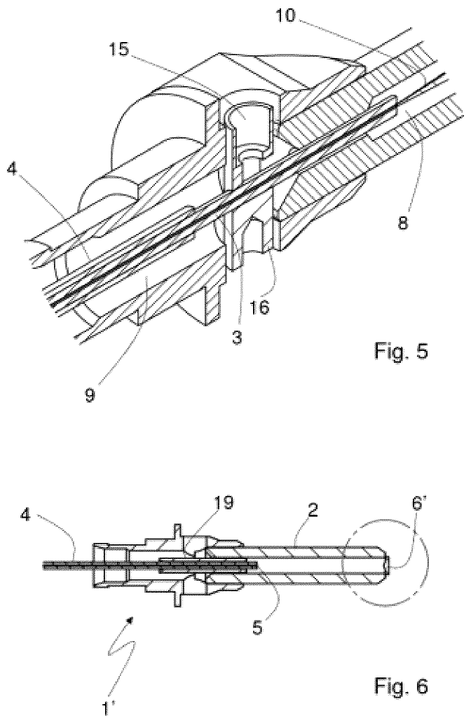

FIGS. 4 and 5 show two partial sectional views of the protective housing 2 with the adjustment device 14, 15 in place, one without optical waveguide (FIG. 4) and one with optical waveguide (FIG. 5), in order to better recognise the arrangement of the end section 3 within the adjustment device 14, 15. It can be seen here that the adjusting device 15, 16 has a transverse hole 17 into which the end section 3 can be inserted. In the direction of the centre section 8 of the through-channel, the transverse hole 17 is connected to a recess 18 through which the adhesive can easily emerge from the sleeve-like element 15.

Corresponding adjustment devices are also provided in the through-channels not shown in order to be able to adjust the other first optical waveguides.

FIG. 6 shows an alternative embodiment of an optical waveguide plug 1′. This embodiment essentially corresponds to the embodiment shown in FIG. 1, wherein, however, an alternatively configured lens 6′ is provided. This lens can be made of quartz glass, silicon or SF11. Correspondingly configured lenses are also provided in the other through-channels not shown.

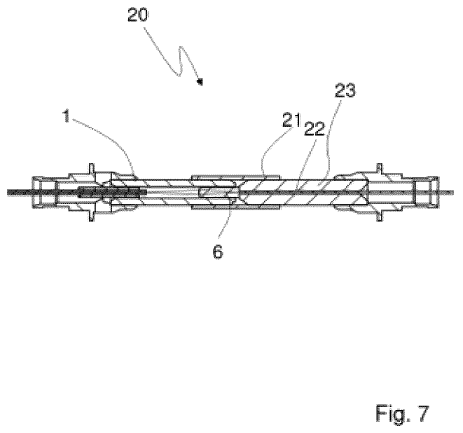

FIG. 7 shows a sectional view of an optical waveguide connector 20. In the left-hand part of FIG. 7, the optical waveguide plug shown in FIG. 1 can be seen. In the right-hand part of FIG. 7, a solid-core optical fibre 22 is arranged within a ferrule 23, as is known from LC plugs of the prior art. The ferrule 23 and the optical waveguide plug 1 are arranged with their end faces inside a sleeve 21. The end face of the solid-core optical waveguide 22 is pressed onto the outlet face 12 of the lens 6 so that physical contact is made. Several solid-core optical waveguides can also be provided. Ideally, the number of solid-core optical waveguides 22 corresponds to the number of optical waveguides (N>1) accommodated in the left optical waveguide plug.

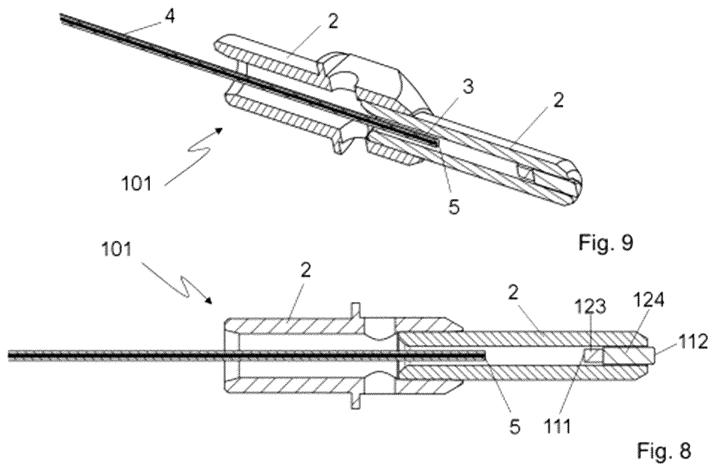

FIGS. 8 (perspective sectional view) and 9 (sectional view) show a third embodiment of an optical waveguide plug 101 according to the invention. Here, identical or essentially identical components have been provided with the same reference signs as in the previous figures. It can be clearly seen here that the lens 123, 124 here comprises two parts, wherein the first part forms the first section 123 and the second part forms the second section 124. The refractive index n₁ in the first section 123 is constant and greater than the refractive index n₂ in the second section 124. The second section 124 has a length in the direction of propagation that is significantly greater (in the example shown, more than twice as long) than the length of the first section 123 in the direction of propagation.

The first section 123 has the entry face 111 and is bonded to the second section 124. The second section 124 has the outlet face 112. It can be clearly seen that the diameter of the second section 124 is larger than the diameter of the first section 123. The diameter of the second section 124 essentially corresponds to the inner diameter of the through-channel of the protective housing 2. This has the advantage that the lens 123,124, with the sections 123,124 already bonded together, can be inserted into the protective housing 2 and is then already correctly positioned laterally. The lenses can also be configured as a lens array. It is then advantageous if the first sections 123 of several—and preferably all—lenses and/or the second sections 124 of several—and preferably all—lenses are configured in one piece, so that all lenses can be positioned together.

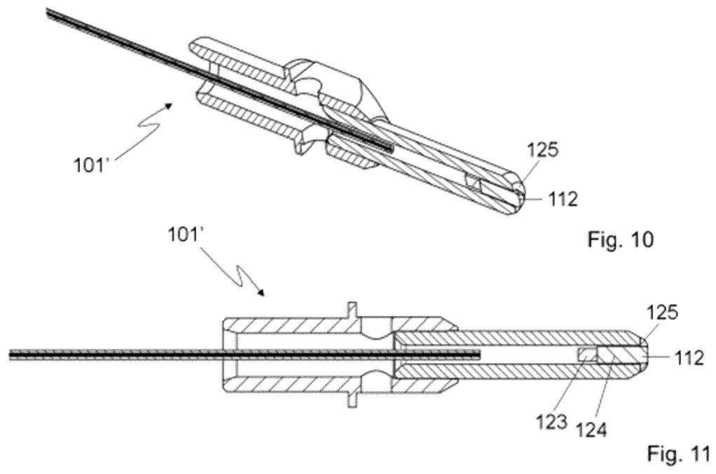

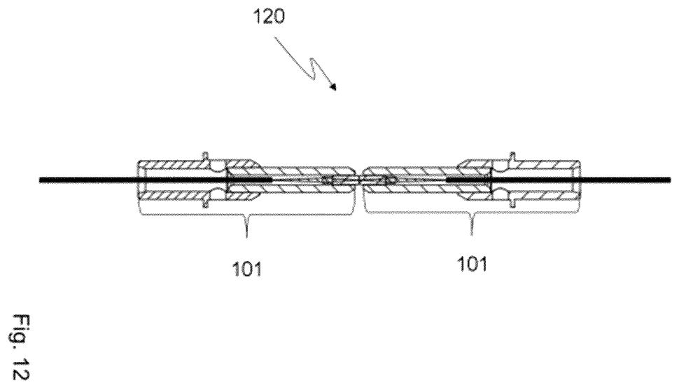

FIGS. 10 (perspective sectional view) and 11 (sectional view) show a fourth embodiment of an optical waveguide plug 101′ according to the invention. Here, identical or essentially identical components have been provided with the same reference signs as in the previous figures. The only difference to the 3rd embodiment is that the second section 124 of the lens is fixed at its end in the through-channel by means of an adhesive 125 in such a way that the outlet face 112 is flush with the adhesive 125. The outlet face 112 remains unwetted by the adhesive 125. The adhesive 125 thus forms a kind of meniscus.

FIG. 12 shows a second embodiment of an optical waveguide connector according to the invention. The illustration essentially corresponds to the illustration of FIG. 7, wherein, however, two optical waveguide plugs 101 according to the invention are now used here in accordance with the third embodiment in order to connect two hollow-core optical waveguides to one another. The other optical waveguides are arranged in parallel and are therefore not visible in the figure.

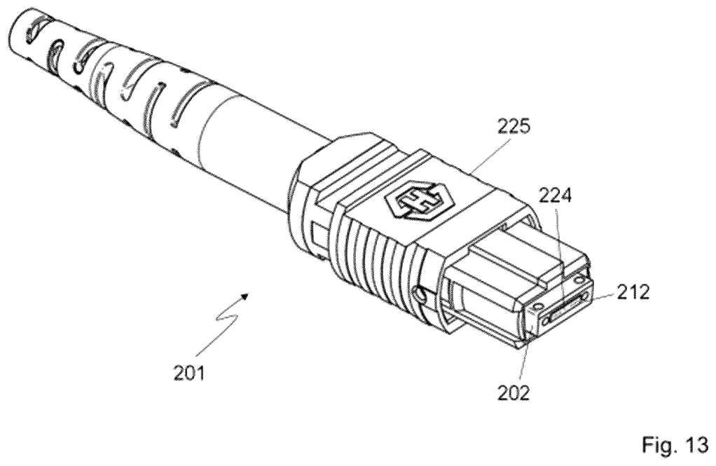

FIGS. 13 to 18 show various views of a fifth embodiment of an optical waveguide plug 201 according to the invention.

In this embodiment, the optical waveguide plug has eight optical waveguides (N=8).

In the perspective view of FIG. 13, a connector jacket 225 can be seen. This connector jacket 225 is known in principle. The protective housing 202 held in the connector jacket 225, the second section 224 of the lenses held therein with their outlet faces 212 can be seen.

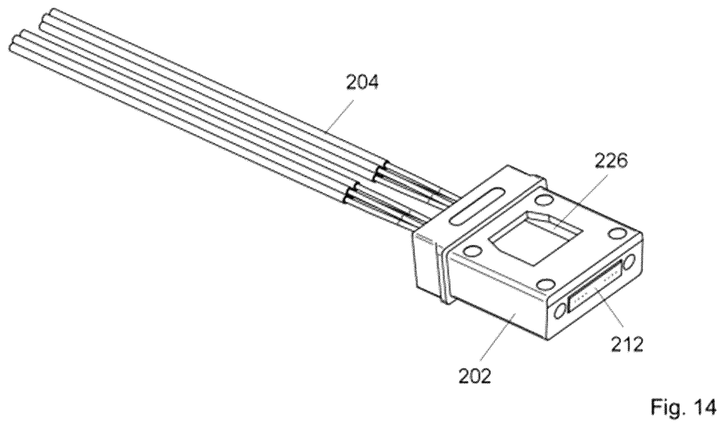

In the perspective view of FIG. 14, the connector jacket 225 has been removed, so that the protective housing 202, the outlet face 212 and the optical waveguides 204 can now be recognised. The adjustment opening 226 can already be seen in this view.

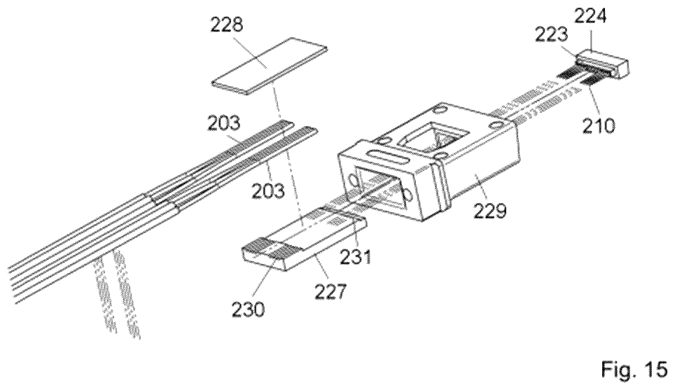

FIG. 15 now shows an exploded view of the parts shown in FIG. 14. The protective housing itself consists of the housing cover 228, the base part 227 and the main housing part 229. The base part 227 has a plurality of alignment structures configured as grooves 230, into which the end sections 203 of the optical waveguides 204 are inserted. With the aid of the grooves 230, the end sections 203 can already be positioned relatively precisely.

The main housing part 229 has two opposing openings, wherein the exit opening, which cannot be seen in FIG. 15, is closed by the first sections 223 and second sections 224, each configured as an array. It can be seen that the base element 227 is configured in a stepped manner on its side facing the lenses in order to provide the lens array with an abutment edge 231. During assembly, the second lens array section 224, including the first lens array section 223 attached thereto, preferably bonded thereto, can therefore be inserted into the rear opening of the main housing part 229 until contact is made with the abutment edge 231.

After the end portions 203 have been positioned in the corresponding grooves 230, the housing cover 228 is placed over the end portions 203, thus forming the upper and lower walls of the protective housing. This “sandwich” is inserted into the front opening of the main housing part 229. The main housing part 229 is configured in such a way that it forms the side walls of the protective housing. The end sections of the 203 and the first sections 223 are therefore arranged in a closed space of the protective housing. The reference number 210 indicates the course of the beam.

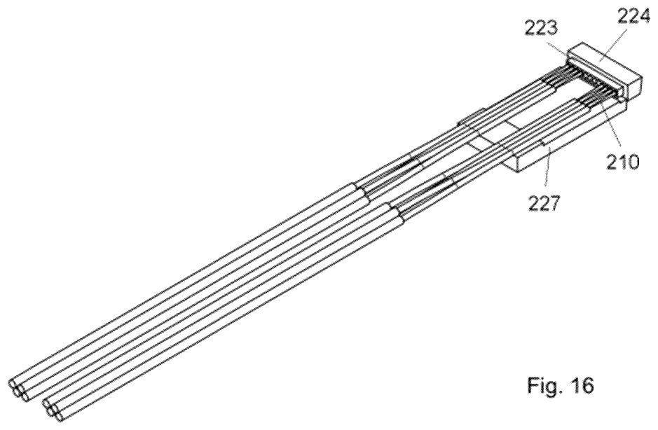

FIG. 16 shows the protective housing in an open state to illustrate the positioning of the individual elements.

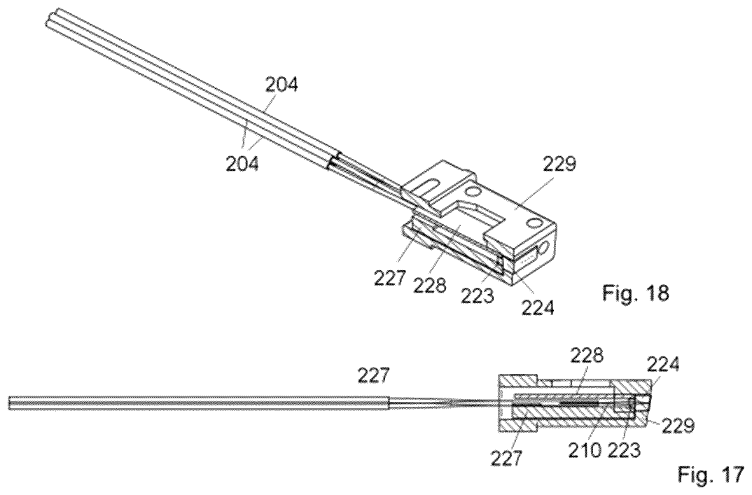

FIGS. 17 and 18 show sectional views of the protective housing, from which the positioning of the individual elements in relation to each other can be seen. If the end sections 203 are not positioned correctly, the position can be corrected via the adjustment opening 226. To do this, either the housing cover 228 must also have an opening or it must be temporarily removed. For example, the grooves 230 could be designed in such a way that they position the end sections 204 slightly too high. With the aid of a manipulator, which may be configured in a V-groove shape, for example, each individual optical waveguide can then be pressed down through the adjustment opening 226 until the correct position has been assumed. The end section is fixed in the final position, for example with the aid of adhesive. Alternatively, the end sections 204 could also already be correctly positioned relative to each other on the base element 227. In this case, only the base element 227 needs to be aligned later relative to the lenses or the lens array 223, 224. Adjustment of each individual end section 204 relative to the lens array 223, 224 can then be omitted.

Once all end sections 203 are correctly positioned and fixed, the housing cover 228 is repositioned or closed.

### REFERENCE SYMBOL LIST

1, 1′, 101, 101′ Optical waveguide plug
2 Protective housing
3 End section
4 Hollow-core optical waveguide
5 End face of the hollow-core optical waveguide
6, 6′ Lens
7 Through-channel
8 Through-channel
9 Through-channel
10 Light beam
11 Entry face
12 Outlet face
13 Transverse channel
14 Adjusting device
15 Adjusting device
16 Handling recess
17 Bore
18 Recess
19 Capillary
20, 120 Optical waveguide connector
21 Solid-core optical waveguide
22 Ferrule
123 First section
124 Second section
125 Adhesive
201 Optical waveguide plug
202 Protective housing
203 End sections
204 Hollow-core optical waveguide
210 Light beam
211 Entry face
212 Outlet face
223 First section
224 Second section
225 Connector jacket
226 Adjustment opening
227 Base element
228 Housing cover
229 Housing main section
230 Groove
231 Abutment edge

What is claimed is:

1. An optical waveguide plug for an optical waveguide connector for optically connecting a number N of first optical waveguides, wherein N is ≥2, to a number M of second optical waveguides, wherein M is ≥1, wherein the optical waveguide plug holds an end portion of each first optical waveguide having an optical waveguide end face and comprises a number N of lenses, each lens having an entry face facing one of the first optical waveguides and an outlet face which faces away from this first optical waveguide, wherein each lens is assigned to exactly one first optical waveguide and each optical waveguide is assigned to exactly one lens, and wherein the lenses are configured and arranged in such a way that a beam of rays emerging from one of the first optical waveguides in a propagation direction strikes the entry face of the assigned lens and is projected as a convergent beam of rays onto the outlet face of the assigned lens.

2. The optical waveguide plug according to claim 1, characterized in that the lens is configured and arranged in such a way that a beam emerging from the first optical waveguide strikes the entry face and is focused onto the outlet face.

3. The optical waveguide plug according to claim 1, characterized in that the optical waveguide plug has a protective housing, wherein both the end sections of the first optical waveguide and each lens are either arranged in the protective housing or close an opening of the protective housing, wherein preferably the protective housing has one or more stops which are provided to abut corresponding abutment surfaces of the end portions of the first optical waveguides and/or the lenses in order to set the position of the end portions of the first optical waveguides and/or the lenses relative to the protective housing in the propagation direction and/or in the lateral direction.

4. The optical waveguide plug according to claim 3, characterized in that the protective housing comprises an input surface and an output surface, between which one or more through-channels extend, wherein preferably N through-channels are provided and both end sections of one of the first optical waveguides and at least one section of one of the lenses are arranged in each through-channel.

5. The optical waveguide plug according to claim 4, characterized in that each lens is arranged completely in one of the through-channels, wherein preferably the outlet faces of the lenses close the corresponding through-channel flush at the output surface.

6. The optical waveguide plug according to claim 4, characterized in that the protective housing has a transverse channel which intersects one of the through-channels, wherein preferably an adjusting device for adjusting the end section of the first optical waveguide arranged in the corresponding through-channel is arranged in the transverse channel, wherein particularly preferably the adjusting device has a sleeve element with a transverse bore or a transverse recess, wherein the end portion of the first optical waveguide is guided through the transverse bore or the transverse recess, wherein preferably the sleeve element and the through-channel are filled with adhesive at least in sections in the region in which the end portion of the corresponding first optical waveguide is arranged.

7. The optical waveguide plug according to claim 3, characterized in that the protective housing is configured in several parts, wherein at least one part has a plurality of grooves for receiving in each case a section of the first optical waveguide, preferably the protective housing fulfils at least protection class IP5X and particularly preferably protection class IP6X.

8. The optical waveguide plug according to claim 1, characterized in that the end face of the first optical waveguide and the associated lens are arranged at a distance from one another.

9. The optical waveguide plug according to claim 1, characterized in that N≤16 and preferably N=8.

10. The optical waveguide plug according to claim 1, characterized in that a plurality and preferably all of the lenses are configured as a lens array.

11. The optical waveguide plug according to claim 1, characterized in that at least one lens and preferably each lens is configured as a 2-section lens and has at least two sections, namely a first section, which is bounded by the entry face, and a second section, which is bounded by the outlet face, wherein the refractive index n₁ of the first section differs from the refractive index n₂ of the second section.

12. The optical waveguide plug according to claim 11, characterized in that the refractive index n2 of the second section is less than the refractive index n1 of the first section, wherein preferably the refractive index n2 is less than 1.5 and particularly preferably 1.5>n₂>1.4.

13. The optical waveguide plug according to claim 11, characterized in that the first section is made of a different material than the second section, wherein preferably the refractive index n₁ within the first section and/or the refractive index n₂ within the second section is constant, wherein particularly preferably the second section has a greater length in the direction of propagation than the first section in the direction of propagation.

14. The optical waveguide plug according to claim 11, characterized in that the 2-section lens is configured in two parts with a first part, which comprises the first section, and a second part, which comprises the second section, wherein the two parts of the 2-section lens particularly preferably have contact faces facing one another, at which the two parts are in contact with one another directly or via an adhesive layer arranged therebetween, so that a beam emerging from the first optical waveguide associated with the 2-section lens strikes the entry face of the first part and enters the second part via the contact faces.

15. The optical waveguide plug according to claim 14, characterized in that the contact face of the second part and the outlet face are each configured to be flat but are not arranged parallel to one another.

16. An optical waveguide connector for optically connecting a number N of first optical waveguides, wherein N≥2, which each have an end section, to a number M of second optical waveguides, wherein M≥1, which each have an end section, with a first optical waveguide plug, in which the end sections of the first optical waveguides are held with a first optical waveguide end face, and a second optical waveguide plug in which the end sections of the second optical waveguides are held with a second optical waveguide end face, wherein each first optical waveguide end face is assigned exactly one second optical waveguide end face, wherein at least one lens is arranged between each first optical waveguide end face and the second optical waveguide end face assigned thereto in such a way that a light beam emerging from the first optical waveguide end face is imaged onto the second optical waveguide end face, wherein the optical waveguide plug according to claim 1 is provided as the first optical waveguide plug.

17. The optical waveguide connector according to claim 16, characterized in that the lens is arranged such that it contacts the second optical waveguide end face, wherein preferably a pre-tensioning device is provided which pre-tensions the output surface of the lens against the second optical waveguide end face.

18. The optical waveguide connector according to claim 16, characterized in that the optical waveguide plug is provided as the second optical waveguide plug.
